(19) United States
(12) Patent Application Publication
(10) Pub. No.: US 2013/0114182 A1
(43) Pub. Date: May 9, 2013

(54) MULTILAYER CERAMIC CAPACITOR

(71) Applicants: Ju Myung SUH, Anyang (KR); Sang Huk Kim, Suwon (KR); Byung Soo Kim, Suwon (KR); Seon Ki Song, Anyang (KR); Jun Hee Kim, Hwaseong (KR); Jae Sung Park, Suwon (KR)

(72) Inventors: Ju Myung SUH, Anyang (KR); Sang Huk Kim, Suwon (KR); Byung Soo Kim, Suwon (KR); Seon Ki Song, Anyang (KR); Jun Hee Kim, Hwaseong (KR); Jae Sung Park, Suwon (KR)

(73) Assignee: Samsung Electro-Mechanics Co., Ltd.

(21) Appl. No.: 13/407,313

(22) Filed: Feb. 28, 2012

(30) Foreign Application Priority Data
Nov. 4, 2011 (KR) 10-2011-0114228

(51) Int. Cl. H01G 4/12

(52) U.S. Cl. 361/321.2

(57) ABSTRACT

There is provided a multilayer ceramic capacitor, including: a ceramic element having a plurality of dielectric layers stacked therein; a plurality of inner electrode layers formed on each dielectric layer; margin dielectric layers each formed on a margin part of each dielectric layer, on which the inner electrode layers are not formed, the margin dielectric layers having a porosity of 10% or less; and outer electrodes formed on outer surfaces of the ceramic element.

### CROSS-REFERENCE TO RELATED APPLICATIONS

This application claims the priority of Korean Patent Application No. 10-2011-0114228 filed on Nov. 4, 2011, in the Korean Intellectual Property Office, the disclosure of which is incorporated herein by reference.

### BACKGROUND OF THE INVENTION

1. Field of the Invention

The present invention relates to a multilayer ceramic capacitor, and more particularly, to a multilayer ceramic capacitor having excellent reliability.

2. Description of the Related Art

Generally, electronic components using a ceramic material such as a capacitor, an inductor, a piezoelectric element, a varistor, or a thermistor, and the like, include a ceramic element made of a ceramic material, inner electrodes formed in the ceramic element, and outer electrodes mounted on surfaces of the ceramic element to be connected to the respective inner electrodes.

A multilayer ceramic capacitor, among ceramic electronic components, includes a plurality of stacked dielectric layers, inner electrodes disposed to oppose each other with the dielectric layer interposed therebetween, and outer electrodes electrically connected to the inner electrodes.

Multilayer ceramic capacitors have been widely used as components of mobile communications devices, such as laptop computers, PDAs, mobile phones, and the like, due to advantages such as miniaturization, high capacity, easiness of mounting, or the like.

Recently, electronic components have been miniaturized, provided with high performance, and have become inexpensive, in accordance with the trend for the high performance compactness and slimness of electric and electronic products. In particular, as the speed of CPUs increases and devices are miniaturized, lightened, digitalized and provided with high functionality, research and development into implementing characteristics such as miniaturization, thinness, high capacity, low impedance in a high frequency area, or the like, in a multilayer ceramic capacitor (hereinafter, referred to as ‘MLCC’), has been actively undertaken.

The dielectric layers and the inner electrode used in highly stacked and high capacity multilayer ceramic condenser are provided as thin type sheets. As thin dielectric layers and thin inner electrodes are highly stacked, deformation and defects are increased during a stacking process and a compressing process, such that it may be difficult to implement an ultrathin, ultra high-capacity multilayer ceramic capacitor.

Recently, in order to increase thin sheet stacking efficiency, a thermal transfer stacking method to transfer a thin sheet at high temperature and high pressure has been used. However, defects of a green chip have been increased due to the increased amount of thin electrodes.

### SUMMARY OF THE INVENTION

An aspect of the present invention provides a multilayer ceramic capacitor having excellent reliability.

According to an aspect of the present invention, there is provided a multilayer ceramic capacitor, including: a ceramic element having a plurality of dielectric layers stacked therein; a plurality of inner electrode layers formed on each dielectric layer; margin dielectric layers each formed on a margin part of each dielectric layer, on which the inner electrode layers are not formed, the margin dielectric layers having a porosity of 10% or less; and outer electrodes formed on outer surfaces of the ceramic element.

Each margin dielectric layer may be formed on at least one of a length-directional margin part and a width-directional margin part of the multilayer ceramic capacitor.

The margin dielectric layers may have a porosity of 3 to 10%.

Each dielectric layer may have a thickness of 2 μm or less.

Each inner electrode layer may have a thickness of 2 μm or less.

The margin dielectric layers may be formed of a ceramic paste composition including ceramic powder, a binder, and a dispersant.

The porosity of the margin dielectric layers may be determined depending on the kinds and contents of components contained in a ceramic paste composition for forming the margin dielectric layers.

The margin dielectric layers may be formed of a ceramic paste composition including ceramic powder having an average particle size of 200 nm or less.

The margin dielectric layers may be formed of a ceramic paste composition including ceramic powder, a first dispersant as a phosphoric acid ester based-dispersant, a second dispersant as an amino ether ester-based dispersant, a binder including polyvinyl butyral and ethyl cellulose, and a solvent.

The ceramic paste composition may further include a preliminary solvent having a viscosity lower than that of the solvent.

A content of the second dispersant maybe 3 to 10 parts by weight based on 100 parts by weight of the ceramic powder.

A content of the binder may be 10 to 20 parts by weight based on 100 parts by weight of the ceramic powder.

The ceramic paste composition may have a viscosity of 5,000 to 20,000 cps.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a multilayer ceramic capacitor according to an embodiment of the present invention;

FIG. 2 is a schematic cross-sectional view showing the multilayer ceramic capacitor taken along line A-A′ of FIG. 1;

FIG. 3 is a schematic cross-sectional view showing the multilayer ceramic capacitor taken along line B-B′ of FIG. 1;

FIG. 4 is a schematic exploded perspective view showing a portion of the multilayer ceramic capacitor shown in FIG. 1; and

FIG. 5 is a partially enlarged view of a portion of FIG. 2.

### DETAILED DESCRIPTION OF THE PREFERRED EMBODIMENT

Embodiments of the present invention will now be described in detail with reference to the accompanying drawings. However, the exemplary embodiments of the present invention may be modified in many different forms and the scope of the invention should not be limited to the embodiments set forth herein. The embodiments of the present invention are provided so that those skilled in the art may more completely understand the present invention. In the drawings, the shapes and dimensions may be exaggerated for clarity, and the same reference numerals will be used throughout to designate the same or like components.

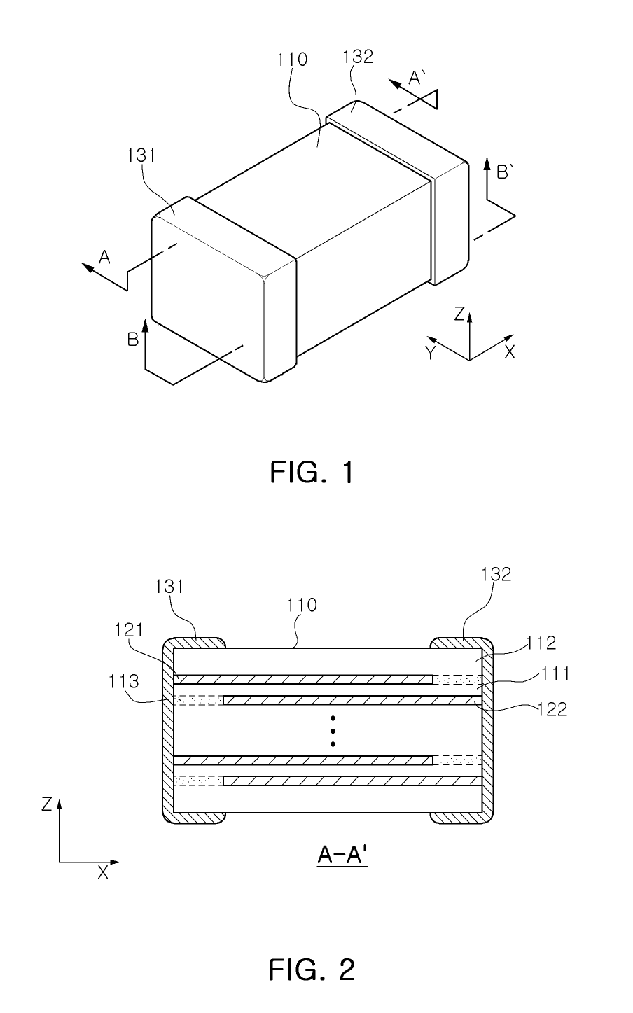

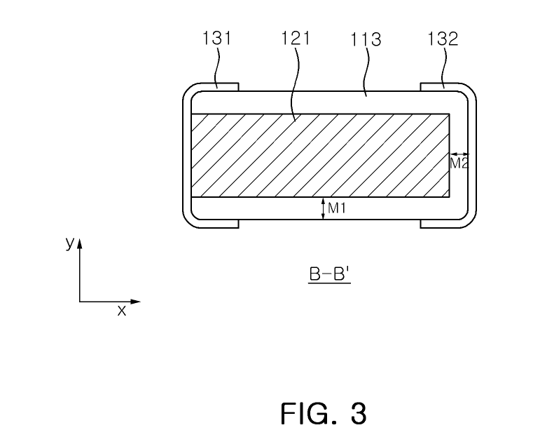

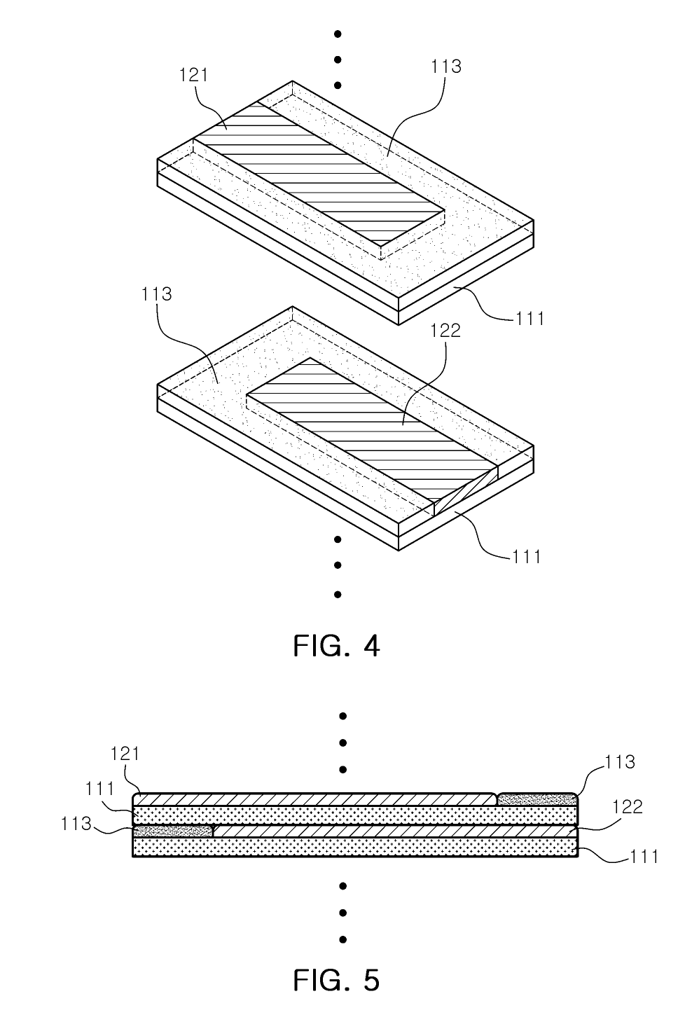

FIG. 1 is a schematic perspective view showing a multilayer ceramic capacitor according to an embodiment of the present invention; FIG. 2 is a schematic cross-sectional view showing the multilayer ceramic capacitor taken along line A-A′ of FIG. 1; FIG. 3 is a schematic cross-sectional view showing the multilayer ceramic capacitor taken along line B-B′ of FIG. 1; FIG. 4 is a schematic exploded perspective view showing a portion of the multilayer ceramic capacitor shown in FIG. 1; and FIG. 5 is a partially enlarged view of a portion of FIG. 2.

Referring to FIGS. 1 through 5, a multilayer ceramic capacitor according to one embodiment of the present invention may include a ceramic element 110 having a plurality of dielectric layers stacked therein, inner electrode layers 121 and 122 formed on each of the dielectric layers, and margin dielectric layers 113, and first and second outer electrodes 131 and 132 formed on outer surfaces of the ceramic element 110.

According to the embodiment of the present invention, a “length direction”, a “width direction”, and a “thickness direction” of the multilayer ceramic capacitor may be defined by an ‘X’ direction, a ‘Y’ direction, and a ‘Z’ direction of FIG. 1, respectively. The ‘thickness direction’ may have the same concept as a direction in which the dielectric layers are staked, that is, a ‘stacking direction’.

The ceramic element 110 is not particularly limited in view of a shape, but may generally have a rectangular parallelepiped shape. Further, the ceramic element 110 is not particularly limited in view of a dimension and may have, for example, a size of 0.6 mm×0.3 mm. The ceramic element 110 may be used for a highly stacked and high capacity multilayer ceramic capacitor of 1.0 μF or more.

The ceramic element 110 may formed by stacking the plurality of dielectric layers in the thickness direction. More specifically, as shown in FIG. 2, the plurality of dielectric layers may include capacitance dielectric layers 111, which are stacked alternately with the inner electrodes to contribute to forma capacitance of the capacitor, and a cover dielectric layer 112, which is formed on the outermost portion of the ceramic element in a predetermined thickness.

According to the embodiment of the present invention, each capacitance dielectric layer 111 may have a thickness, which is arbitrarily changed depending on a capacitance design of the multilayer ceramic capacitor. In the embodiment of the invention, a thickness of each capacitance dielectric layer 111 after sintering may be 2.0 μm or less.

The plurality of inner electrodes 121 and 122 may be formed within the ceramic element. The inner electrodes 121 and 122 may be formed on ceramic green sheets for forming capacitance dielectric layers 111, to be stacked, and then be subjected to sintering. Thus, the inner electrodes 121 and 122 may be formed within the ceramic element 110, while having each capacitance dielectric layer 111.

These inner electrode layers 121 and 122 may be configured as pairs of a first inner electrode layer (denoted by reference numeral 121) and a second inner electrode layer (denoted by reference numeral 122) having opposite polarities, and may be arranged to oppose to each other while having each capacitance dielectric layer 111 interposed therebetween in the stacking direction.

Respective ends of the first and second inner electrode layers 121 and 122 may be exposed to surfaces of the ceramic element 110. The ends of the first and second inner electrodes 121 and 122 in the length direction (X direction) are alternately exposed to both end surfaces of the ceramic element 110 facing each other, as shown in FIG. 2, but the present invention is not limited thereto.

In the present invention, a region of each dielectric layer, on which the inner electrode layers are not formed may be referred to as a margin part, and the dielectric layer formed on the region may be referred to as a margin dielectric layer. As shown in FIG. 3, a margin part formed in the width direction (Y direction) of the multilayer ceramic capacitor may be referred to as a width-directional margin part (M1), and a margin part formed in the length direction (X direction) of the multilayer ceramic capacitor may be referred to as a length-directional margin part (M2).

Referring to FIGS. 2 through 4, the length-directional margin part (M2) without having the first inner electrode layer 121 or the second inner electrode layer 122 formed thereon may be formed in the length direction (X direction) of each capacitance dielectric layer 111, and the width-directional margin part (M1) without having the first inner electrode layer 121 or the second inner electrode layer 122 formed thereon may be formed in the width direction (Y direction) of each capacitance dielectric layer 111.

Although not shown, the respective ends of the first and second inner electrode layers may be exposed to the same surface of the ceramic element. Also, the respective ends of the first and second inner electrode layers 121 and 122 may be exposed to two or more surfaces of the ceramic element.

The thicknesses of the first and second inner electrode layers 121 and 122 may be appropriately determined depending on an intended purpose thereof or the like, and for example, the first and second inner electrode layers 121 and 122 may each have a thickness of 2.0 μm or less. Alternately, the thickness thereof may be selected in the range of 0.3 to 1.5 μm.

The first and second outer electrodes 131 and 132 may be formed on the outer surfaces of both end portions of the ceramic element 110, and may be connected to the respective ends of the first and second inner electrode layers 121 and 122, which are exposed to the surfaces of the ceramic element.

A conductive material contained in the first and second outer electrodes 131 and 132 is not particularly limited, but Ni, Cu, or an alloy thereof may be used. The thicknesses of the first and second outer electrodes 131 and 132 may be appropriately determined depending on an intended purpose thereof or the like, and for example, the first and second outer electrodes 131 and 132 may each have a thickness of 10 to 50 μm.

According to the embodiment of the present invention, “first” and “second” may mean opposite polarities.

According to the embodiment of the present invention, the dielectric layers constituting the ceramic element 110 may contain ceramic powder generally used in the art. Although not limited thereto, the dielectric layers may contain, for example, a BaTiO₃-based ceramic powder. The BaTiO₃-based ceramic powder may be, but not limited to, (Ba₁₋ₓCaₓ)TiO₃, Ba(Ti_{1-y}Ca_{y})O₃, (Ba₁₋ₓCaₓ) (Ti_{1-y}Zr_{y})O₃, Ba(Ti_{1-y}Zr_{y})O₃, or the like, in which, for example, Ca, Zr, or the like is employed in BaTiO₃.

The ceramic powder may have an average grain size of, for example 0.8 μm or less, and more preferably 0.05 to 0.5 μm, but is not limited thereto.

In addition, the dielectric layers may contain transition metal oxides, carbides, rate earth elements, Mg, Al, or the like, together with the ceramic powder.

According to the embodiment of the present invention, the margin dielectric layers 113 may be formed on each capacitance dielectric layer 111.

Referring to FIGS. 3 through 5, according to the embodiment of the present invention, the inner electrode layers 121 and 122 may be formed on the capacitance dielectric layer 111, and each margin dielectric layer 113 may be formed on the margin parts (M1 and M2) of the capacitance dielectric layer 111, on which the inner electrode layers 121 and 122 are not formed.

FIGS. 3 through 5 illustrate a portion of the multilayer ceramic capacitor according the embodiment of the invention, and the outer electrodes are omitted.

Referring to FIGS. 3 through 5, the margin dielectric layers 113 may be formed on both of the width-directional margin part M1 and the length-directional margin part M2. However, without being limited thereto, the margin dielectric layer may be formed on only the width-directional margin part M1 or the length-directional margin part M2. Also, the margin dielectric layer may be formed on the entire region or only a partial region of the width-directional margin part M1 or the length-directional margin part M2.

According to the embodiment of the present invention, the margin dielectric layer may have a height the same as, or similar to, that of the inner electrode formed on the capacitance dielectric layer.

According to the embodiment of the present invention, a step height occurring due to the inner electrode layer may be solved by the formation of the margin dielectric layers 113 and diffusion of the inner electrode layer may be prevented.

According to the embodiment of the present invention, the margin dielectric layers 113 may have a porosity of 10% or less. Also, the margin dielectric layers 113 may have a porosity of 3 to 10%.

If the porosity of the margin dielectric layers is above 10%, density at the margin parts of the multilayer ceramic capacitor may be deteriorated, resulting in degraded moisture resistance properties. Therefore, IR deterioration may occur, and thus, reliability of the multilayer ceramic capacitor may be deteriorated. If dispersibility of the ceramic powder is extremely increased in order to lower the porosity of the margin dielectric layers, a de-binder path is blocked during a baking process to cause cracks in baking and sintering processes.

In particular, since a dielectric paste printed part is the margin part, occurrence of the cracks may be further increased.

According to the embodiment of the present invention, the margin dielectric layers may be formed of a paste composition containing a fine grain ceramic powder. In the present invention, the paste composition for forming the margin dielectric layers may be called a ceramic paste composition for a margin part (hereinafter, referred to as “a margin ceramic paste composition”).

According to the embodiment of the present invention, a range of the porosity of the margin dielectric layers may be determined depending on a dispersion degree of the ceramic powder contained in the margin ceramic paste composition. Also, the porosity of the margin dielectric layers may be determined depending on components of the margin ceramic paste composition and contents of the respective components.

Hereinafter, the margin ceramic paste composition according to the embodiment will be described in detail.

A method of preparing the margin ceramic paste composition will be mainly described, and therefore, the components of the margin ceramic paste composition will be apparent.

In order to prepare the margin ceramic paste composition, first, a primary mixture in a slurry state is prepared, the primary mixture including a preliminary solvent, a first dispersant, and ceramic powder. The primary mixture in a slurry state may have a viscosity of 10 to 300 cps, preferably, 50 to 100 cps.

The preliminary solvent is to prepare a mixture in a slurry state and may have a relatively low viscosity. Examples of the preliminary solvent may include toluene, ethanol, and a mixed solvent thereof, but is not limited thereto. The content of the preliminary solvent may be appropriately selected in consideration of the viscosity of the slurry and the contents and properties of other components. For example, the content of the preliminary solvent may be 100 to 500 parts by weight based on 100 parts by weight of the ceramic powder.

The first dispersant may be a phosphoric acid ester-based dispersant. The phosphoric acid ester-based dispersant is combined onto a surface of the ceramic powder so as to improve dispersibility of the ceramic powder having a small average particle size. In addition, the phosphoric acid ester-based dispersant may prevent the viscosity of the primary mixture in a slurry state from being deteriorated.

Specific types of the phosphoric acid ester-based dispersant are not particularly limited. Examples of the phosphoric acid ester-based dispersant may include, but not limited to, for example, trimethyl phosphate, triethyl phosphate, tributyl phosphate, trioctyl phosphate, triphenyl phosphate, tricresyl phosphate, trixyleyl phosphate, cresyldiphenyl phosphate, octyldiphenyl phosphate, and the like, and they may be used alone, or two or more types thereof may be used.

The content of the phosphoric acid ester-based dispersant may be 5 to 20 parts by weight based on 100 parts by weight of the ceramic powder.

The types of the ceramic powder is not particularly limited, and may be the same or similar to ceramic powder used in the capacitance dielectric layers 111.

The ceramic powder may have an average particle size of 200 nm or less. The primary mixture in a slurry state has a relatively low viscosity, and thus, ceramic powder having a small particle size may be uniformly dispersed therein. The ceramic powder may have an average particle size of 200 nm or less, preferably 50 to 100 nm.

The primary mixture in a slurry state has a relatively low viscosity, and thus dispersibility of the ceramic powder may be improved through deagglomeration.

The deagglomeration of the primary mixture may be performed by using a bead mill or a high-pressure sprayer while applying strong impacts and stress thereto. The deagglomeration conditions may be a casting rate of 5 to 10 m/s, a flux of 30 to 80 hg/hr (using a high shear micro-mill), and a solid content of about 20 to 50 wt/%, but are not limited thereto. After the deagglomeration, dispersibility of the ceramic powder may be confirmed by measuring a grain size, a specific surface area (BET), and a fine shape of the ceramic powder through a scanning electron microscope (SEM).

Next, a solvent, a second dispersant, and a binder are added to the primary mixture to prepare a secondary mixture in a paste state. The secondary mixture in a paste state has a high viscosity suitable for printing. The viscosity of the secondary mixture may be 5,000 to 20,000 cps. The viscosity of the secondary mixture may be regulated in an appropriate range depending on a printing method. The secondary mixture may have a viscosity of 7,000 to 25,000 cps in a screen printing process.

The secondary mixture is in a high-viscosity paste state, and a dispersion process using a method such as 3-roll milling or the like may be performed on the secondary mixture.

The solvent has a higher boiling point and a higher viscosity as compared to those of the preliminary solvent used in the primary mixture. A material generally used in preparing a paste may be used for the solvent. Specific types of the solvent are not limited, but for example, terpioneol-based solvent may be used. More specifically, dihydro terpineol (DHTA) may be used.

The terpineol-based solvent is advantageous to prepare a paste due to the high viscosity thereof, and advantageous for leveling characteristics after printing due to a slow drying rate thereof caused by a high boiling point thereof.

The second dispersant used in the secondary mixture may be an amino ether ester-based dispersant.

The amino ether ester-based dispersant may improve dispersibility of ceramic powder in a high-viscosity paste state.

The content of the second dispersant may be 3 to 20 parts by weight based on 100 parts by weight of the ceramic powder. Also, the content of the second dispersant may be 3 to 10 parts by weight based on 100 parts by weight of the ceramic powder. If the content of the secondary dispersant is below 3 parts by weight, dispersibility of the ceramic powder is deteriorated, which causes porosity of the margin dielectric layers to be increased after sintering.

The binder used in the secondary mixture may be polyvinyl butyral and ethylcellulose. The binder may be coated on the surface of the ceramic powder during the dispersion of the secondary mixture. Therefore, agglomeration of the ceramic powder may be minimized and dispersion stability of the ceramic powder may be maintained.

Also, the binder serves to impart appropriate ranges of viscosity and thixotrophy in order to allow the secondary mixture to be applied to printing methods such as screen printing, gravure printing, and the like. Also, the binder serves to realize physical properties such as adhesion, phase stability, and 3-roll milling possibilities.

The polyvinyl butyral has an excellent bond with the ceramic powder. Since the ethyl cellulose is excellent in structure resilience to improve dispersion stability of a ceramic paste, adhesion strength may be adjusted according to the addition of ethyl cellulose.

The content of the binder may be set in consideration of dispersibility of the ceramic powder, as well as laminatability and debindering. The content of the binder may be set to be in a range similar to the content of the binder contained in the ceramic paste forming the the capacitance dielectric layers. The content of the binder may be, but is not limited to, 10 to 30 parts by weight based on 100 parts by weight of the ceramic powder. The content of the binder may be 10 to 20 parts by weight based on 100 parts by weight of the ceramic powder.

If the content of the binder is below 10 parts by weight, dispersibility of the ceramic paste may be deteriorated or printing characteristics may be degraded, resulting in increasing porosity of the margin dielectric layers. Also, if the content of the binder is above 30 parts by weight, debindering is difficult, resulting in degrading properties of the multilayer ceramic capacitor.

Also, a plasticizer may be further added to the secondary mixture. The plasticizer may be a triethylene glycol-based plasticizer.

The content of the plasticizer may be, but is not limited to, 10 to 30 parts by weight based on 100 parts by weight of the ceramic powder.

Before the secondary mixture is formed, the preliminary solvent may be removed. The preliminary solvent may be volatilized and removed by a distiller due to a low boiling point thereof. When the preliminary solvent is removed, the primary mixture in a slurry state may become a wet cake state. Therefore, the solvent used in the secondary mixture is added to the primary mixture in the wet cake state to prepare the secondary mixture in the paste state.

Here, it is preferable to completely remove the preliminary solvent, but a part of the preliminary solvent may not be removed to remain in the secondary mixture.

When the preliminary solvent remains, there may be a risk that the capacitance dielectric layer is damaged. Therefore, a removal rate of the preliminary solvent may be preferably as high as possible.

However, the addition of the second dispersant, the binder, or the solvent may cause the removal of the preliminary solvent to be difficult. Therefore, in order to increase the removal rate of the preliminary solvent, the removal of the preliminary solvent may be performed before the addition of the solvent, the second dispersant, and the binder for forming the secondary mixture.

According to the preparing method as above, the ceramic paste composition may include the ceramic powder, the first dispersant as a phosphoric acid ester based dispersant, the second dispersant as an amino ether ester-based dispersant, the binder including polyvinyl butyral and ethyl cellulose, and the solvents. In some cases, the preliminary solvent having lower viscosity than that of the solvent may be included.

In general, metal powder for forming the inner electrode layers or ceramic powder having a large average particle size may be dispersed through a 3-roll milling process at high viscosity.

However, since ceramic powder having a small average particle size has a large specific surface area and high hardness, dispersibility thereof is difficult to secure at high viscosity. Further, ceramic powder having a smaller particle size needs to be applied to micro-miniature, ultra thin film type multilayer ceramic capacitors, and in this case, securing dispersibility thereof is more difficult. For this reason, when the dispersibility of ceramic powder is not sufficiently secured, the porosity of the margin dielectric layers is increased after sintering, moisture resistance property and reliability may be deteriorated.

According to the embodiment, the preliminary solvent having a low viscosity in accordance with fine grain ceramic powder is used and deagglomeration and dispersion are performed, whereby the agglomeration of the ceramic powder is minimized to secure dispersibility thereof. Hereinafter, the solvent having a high viscosity is used to prepare a high-viscosity paste for printing. Therefore, the fine grain ceramic powder may be included.

Also, the porosity of the margin dielectric layers may be in the range of 10% or less by using the ceramic paste having dispersibility superior than that of the existing paste.

Hereinafter, a method of manufacturing the multilayer ceramic capacitor according to the embodiment of the present invention will be described.

First, a plurality of ceramic green sheets are prepared. A slurry is prepared by mixing ceramic powder, a binder, and a solvent and molded into a sheet shape having a thickness of several micrometers (μm) using a doctor blade method to fabricate the plurality of ceramic green sheets. The slurry may be a ceramic green sheet slurry for forming the capacitance dielectric layers and the cover dielectric layer of the ceramic element.

Next, a conductive paste for an inner electrode is applied to the ceramic green sheets to form the first and second inner electrode layers. The first and second inner electrode layers may be formed by a screen printing method or a gravure printing method.

Next, the margin dielectric layers are formed on a margin part of each ceramic green sheet, on which the inner electrode layers are not formed.

The ceramic paste for a multilayer ceramic capacitor according to the embodiment of the invention as described above is printed on the margin part of each ceramic green sheet on which the first and second inner electrode layers are not formed, and then sintered, thereby forming the margin dielectric layers shown in FIGS. 4 and 5. The ceramic paste for a multilayer ceramic capacitor may be fabricated by the method as described above. The ceramic green sheets may be subjected to sintering to thereby form the dielectric layers shown in FIGS. 4 and 5.

Next, the plurality of ceramic green sheets thus obtained are stacked, and then pressure is applied thereto in the stacking direction, thereby compressing the stacked ceramic green sheets and the first and second inner electrode layers to each other. By doing so, a ceramic laminate, in which the ceramic green sheets and the first and second inner electrode layers are alternately stacked, is fabricated. Here, the inner electrode layers may be stretched or protruded outwardly of the ceramic green sheets during the compressing. However, according to the embodiment of the present invention, the diffusion of the first and second inner electrode layers may be prevented by the ceramic paste (the margin dielectric layers) printed on the margin part of each ceramic green sheet, on which the first and second inner electrode layers are not formed. Further, the occurrence rate of a step due to the inner electrode layers in the ceramic element may be reduced.

Next, the ceramic laminate is cut into units of a region corresponding to one capacitor and individualized into each chip. At the time of cutting, the cutting is performed such that the respective ends of the first and second inner electrode layers may be alternately exposed to both end surfaces of the individualized chip.

Then, the individualized chip is sintered at a temperature of, for example, 1200° C., whereby the ceramic element 110 may be manufactured.

Then, the first and second outer electrodes may be formed to cover the end surfaces of the ceramic element and be electrically connected to the first and second inner electrode layers exposed to the end surfaces of the ceramic element. Thereafter, surfaces of the first and second outer electrodes 131 and 132 may be plated by using nickel, tin, or the like.

As described in Tables 1 through 3 below, margin ceramic paste compositions were prepared, which were then used to manufacture multilayer ceramic capacitors. Samples 1 to 4 listed in Table 1 were different in view of the content of the binder but the same in view of the other conditions in the margin ceramic paste compositions. Samples 1 to 4 listed in Table 2 were different in view of the content of the second dispersant but the same in view of the other conditions in the margin ceramic paste compositions.

Each ceramic packing rate before sintering, described in Tables 1 through 3 below, means vol % of the ceramic powder occupying in the total volume of additives. In other words, since the volume of the ceramic powder before sintering in the total volume is increased to the maximum, resulting in minimized pores after sintering, the volume of the ceramic powder before sintering needs to be managed. However, since there is an error between measured density and theoretical density when the ceramic packing rate is calculated, the ceramic vol % is divided by relative density. Density measurement was performed by Archimedes' method, after drying the margin ceramic paste composition, and equations are as follows.

Packing rate (vol %)=BT (vol %)/Relative density

Relative density=Measured density (g/cc)/Theoretical density (g/cc)

Porosity after sintering is expressed by percent (%) of an area of pores in the margin dielectric layer after sintering. The pores were still present even after sintering due to deterioration in dispersibility and the presence of internal defects, resulting in a reduction in density after sintering. A fine structure of the margin dielectric layer after sintering was actually photographed, and then porosity (%) per area of the margin dielectric layer was calculated.

TABLE 1

| | Sample | Sample | Sample | Sample |
|---|---|---|---|---|
| | 1 | 2 | 3 | 4 |
| Content of Binder | 10 | 13 | 16 | 20 |
| (Parts by weight) | | | | |
| Dispersibility Rmax (μm) | 0.210 | 0.153 | 0.070 | 0.892 |
| Dry Fim Density (g/cm³) | 3.38 | 3.32 | 3.54 | 3.41 |
| Packing rate before | 40.52 | 42.58 | 48.98 | 46.92 |
| Sintering (%) | | | | |
| Packing rate after | 10.3 | 8.2 | 3.1 | 5.6 |
| Sintering (%) | | | | |

TABLE 2

| | Sample | Sample | Sample | Sample |
|---|---|---|---|---|
| | 5 | 6 | 7 | 8 |
| Content of Second Dispersant | 2.0 | 3.0 | 4.0 | 5 |
| (Parts by weight) | | | | |
| Dispersibility Rmax (μm) | 0.212 | 0.158 | 0.070 | 0.193 |
| Dry Fim Density (g/cm³) | 3.48 | 3.42 | 3.54 | 3.31 |
| Packing rate before | 44.21 | 45.65 | 48.98 | 43.85 |
| Sintering (%) | | | | |
| Packing rate after | 10.5 | 9.2 | 3.1 | 4.0 |
| Sintering (%) | | | | |

TABLE 3

| | Sample 9 | Sample 10 | Sample 11 |
|---|---|---|---|
| Particle size of Ceramic Powder | 50 | 80 | 100 |
| (nm) | | | |
| Dispersibility Rmax (μm) | 0.085 | 0.070 | 0.127 |
| Dry Fim Density (g/cm³) | 3.38 | 3.54 | 3.24 |
| Packing rate before Sintering (%) | 47.14 | 48.98 | 45.28 |
| Packing rate after Sintering (%) | 4.8 | 3.1 | 9.5 |

Referring to Table 1, in each of Samples 2 to 4, the content of the binder contained in the margin ceramic paste composition was controlled, so that the porosity of the margin dielectric layers after sintering was 10% or less. Whereas, in Sample 1, the content of the binder was small, so that the porosity of the margin dielectric layers after sintering was exceeded 10%.

Also, referring to Table 2, in each of Samples 6 to 8, the content of the second dispersant contained in the margin ceramic paste composition was controlled, so that the porosity of the margin dielectric layers after sintering was 10% or less. Whereas, in Sample 5, the content of the second dispersant was small, so that the porosity of the margin dielectric layers after sintering exceeded 10%.

Also, referring to Table 3, in each of Samples 9 to 11, the ceramic powder having a particle size of 100 nm or less was used, so that the porosity of the margin dielectric layers after sintering was 10% or less.

In other words, according to the embodiment of the present invention, it is determined that dispersibility of the ceramic powder is improved, and thus, agglomeration of particles is reduced, resulting in a decrease in the porosity of the margin dielectric layers.

In addition, a reliability test (8585 Test, in the conditions of −85° C., 85% RH, 6.5V/9.45V, 12 Hr, 400 pcs) was performed on the multilayer ceramic capacitors (0603 size) according to Samples 1 to 4, and the results were shown in Table 4.

TABLE 4

| | Sample | Sample | Sample | Sample |
|---|---|---|---|---|
| | 1 | 2 | 3 | 4 |
| The Number of moisture resistant | 35 | 31 | 10 | 25 |
| IR deterioration chips (%) | | | | |

Referring to Table 4, the occurrence of IR deterioration rate was reduced in each of Samples 2 to 4 showing that the porosity of the margin dielectric layers after sintering was 10% or less. Whereas, the occurrence of IR deterioration rate was more increased in Sample 1 showing that the porosity of the margin dielectric layers after sintering exceeded 10%, as compared with the cases of Samples 2 to 4.

Since the ceramic paste prepared according to the embodiment of the present invention is printed on the margin part of the dielectric layer, stretching of the electrodes may be prevented in stacking and compression processes, thereby increasing a cutting yield.

In addition, since the margin dielectric layers are formed to have a porosity of 10% or less, density in the margin part of the multilayer ceramic capacitor is not decreased, thereby improving moisture resistance property. Therefore, the occurrence of IR deterioration rate may be lowered and reliability of the multilayer ceramic capacitor may be improved.

As set forth above, according to the embodiment of the present invention, the margin dielectric layers formed in the multilayer ceramic capacitor can have a porosity of 10% or less. For this reason, density in the margin part of the multilayer ceramic capacitor is not decreased, and thus, moisture resistance property can be improved. Therefore, the occurrence of IR deterioration rate can be lowered and reliability of the multilayer ceramic capacitor can be improved.

According to the embodiment of the present invention, the margin ceramic paste composition may be prepared by using a solvent suitable for dispersion conditions of the ceramic powder and then changing the solvent into another solvent suitable for printing. Thus, it is possible to use ceramic powder having a small particle size, and thus, the ceramic powder can have excellent dispersibility in a ceramic paste.

When the ceramic paste according to the embodiment of the present invention is used to form the margin dielectric layer in the multilayer ceramic capacitor, sinterability can be improved and deformation of the inner electrodes can be prevented.

Since the ceramic paste prepared according to the embodiment of the present invention is printed on the margin part of the dielectric layer, stretching of the electrodes can be prevented in stacking and compression processes, thereby increasing the cutting yield.

As a result, the present invention can contribute to the model development of micro-miniature and ultra-thin multilayer ceramic capacitors.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic capacitor, comprising:
a ceramic element having a plurality of dielectric layers stacked therein;
a plurality of inner electrode layers formed on each dielectric layer;
margin dielectric layers each formed on a margin part of each dielectric layer, on which the inner electrode layers are not formed, the margin dielectric layers having a porosity of 10% or less; and
outer electrodes formed on outer surfaces of the ceramic element.

2. The multilayer ceramic capacitor of claim 1, wherein each margin dielectric layer is formed on at least one of a length-directional margin part and a width-directional margin part of the multilayer ceramic capacitor.

3. The multilayer ceramic capacitor of claim 1, wherein the margin dielectric layers have a porosity of 3 to 10%.

4. The multilayer ceramic capacitor of claim 1, wherein each dielectric layer has a thickness of 2 μm or less.

5. The multilayer ceramic capacitor of claim 1, wherein each inner electrode layer has a thickness of 2 μm or less.

6. The multilayer ceramic capacitor of claim 1, wherein the margin dielectric layers are formed of a ceramic paste composition including ceramic powder, a binder, and a dispersant.

7. The multilayer ceramic capacitor of claim 1, wherein the porosity of the margin dielectric layers is determined depending on the kinds and contents of components contained in a ceramic paste composition for forming the margin dielectric layers.

8. The multilayer ceramic capacitor of claim 1, wherein the margin dielectric layers are formed of a ceramic paste composition including ceramic powder having an average particle size of 200 nm or less.

9. The multilayer ceramic capacitor of claim 1, wherein the margin dielectric layers are formed of a ceramic paste composition including ceramic powder, a first dispersant as a phosphoric acid ester based-dispersant, a second dispersant as an amino ether ester-based dispersant, a binder including polyvinyl butyral and ethyl cellulose, and a solvent.

10. The multilayer ceramic capacitor of claim 9, wherein the ceramic paste composition further includes a preliminary solvent having a viscosity lower than that of the solvent.

11. The multilayer ceramic capacitor of claim 9, wherein a content of the second dispersant is 3 to 10 parts by weight based on 100 parts by weight of the ceramic powder.

12. The multilayer ceramic capacitor of claim 9, wherein a content of the binder is 10 to 20 parts by weight based on 100 parts by weight of the ceramic powder.

13. The multilayer ceramic capacitor of claim 9, wherein the ceramic paste composition has a viscosity of 5,000 to 20,000 cps.
